(19) United States
(12) Patent Application Publication
(10) Pub. No.: US 2012/0179551 A1
(43) Pub. Date: Jul. 12, 2012

(54) Personalised Items in Mobile Devices based on User Behaviour

(75) Inventor: Apostolos Georgakis, Stockholm (SE)

(73) Assignee: TELEFONAKTIEBOLAGET LM ERICSSON (PUBL), Stockholm (SE)

(21) Appl. No.: 13/498,015

(22) PCT Filed: Sep. 28, 2009
(86) PCT No.: PCT/SE2009/051076

§ 371 Date: Mar. 23, 2012

(51) Int. Cl. G06Q 30/02

(52) U.S. Cl. 705/14.64

(57) ABSTRACT

A method and arrangement for enabling purchase of an item offered by an item provider. The content of a communication session in which a user takes part at a communication network is analysed (200). Based on the content, one or more user profiles are created (202). Each profile is divided in a plurality of categories. The categories may represent preferences, plans, and other information analysed from the content of the communication session. Purchase offers regarding provided items are received (204) from the item provider by the purchase unit. The items are matched (206) with at least one user profile by the purchase unit, and the purchase offers regarding the matching item is conveyed (208) to the user. By creating and/or updating user profiles based on the content of a user's communication sessions, the user can be offered more personalised purchase offers, without being offered generic purchase offers.

### TECHNICAL FIELD

The invention relates generally to a method and arrangement for providing purchase offers to a user regarding items offered by an item provider. In particular, the present invention can be used where the user speaks in a mobile phone.

### BACKGROUND

With the emergence of mobile communication systems, new mobile services have been developed for supporting exchange of information between different types of communicating parties. A communication network can be used to convey e.g. speech, text, etc. between communication terminals used by communicating parties or users of the system. Various types of text-messages, e.g. SMS (Short Message Service), or MMS (Multimedia Message Service), as well as speech can be exchanged between communicating parties during a communication session.

In this description, the term “item” is used to define any type of article, product, service, etc. provided by an item provider. Such an item may be any product offered in a shop, a meal at a restaurant, mending a car, cleaning a house, giving economic advices, baby-sitting, etc. A communicating party can be a person taking part in a communication session, an item provider sending purchase offers, etc. Such an item provider can be a shop, a restaurant, or a service provider, etc.

Today, there exists some methods for personalised advertising in communication networks, and these will be briefly described below. Known systems for personalised advertising are based on extracting specific keywords from a communication session and match advertisements in a database with extracted keywords, to identify suitable advertisements and deliver to the users. Such methods and systems are disclosed in e.g. US2007201636, US2002103647, US20060067497, US2008115163, and US20080294436.

However, there are certain problems associated with the existing solutions. For instance, even extracting specific keywords from a communication session and match with offered items, results in that the user receives relatively generic purchase offers, which may be perceived annoying to a the user receiving the purchase offers.

### SUMMARY

It would be desirable to be provided with a reasonable amount of relevant information. It is an object of the invention to address at least some of the problems outlined above. Further, it is an object of the invention to provide a mechanism for enabling an amount of information that is relevant to a communicating party. These objects may be met by a method and an apparatus according to the attached independent claims.

According to one aspect a method is provided for enabling purchase of an item. The method comprises the following steps being executed in a communication network node. The content of at least one communication session in which a user takes part is analysed. Based on the analysis, at least one user profile is created. The user profile being divided in more than one category. One or more purchase offers regarding one or more items are received from an item provider. The user is matched with the item(s), based on the user profile(s). Finally, a message is conveyed to the user including at least one purchase offer regarding the matching item(s).

In one embodiment, the categories represent characteristics representing the user's plans, intentions, needs, etc. The categories may further comprise the user's geolocation and the session time when the communication session is performed. In another embodiment, the message comprising the purchase offer(s) may include a verification code, e.g. in order to enable the item provider to verify the purchase offer.

According to another aspect a purchase unit is provided for providing purchase offers to a user regarding items offered by an item provider. The purchase unit comprises a first communication unit adapted to receive information on at least one communication session in which a user takes part. Furthermore, a profile processor is comprised, the profile processor being adapted to analyse the content of the communication session, and further adapted to create at least one user profile based on the analysis. The purchase unit comprises also a second communication unit adapted to receive the purchase offer(s) from the item provider.

Moreover, the profile processor is further adapted to match at least one offered item with the user based on at least one user profile, and the first communication unit (302) is further adapted to convey at least one message to the user, including the at least one purchase offer regarding the at least one matching item.

According to a further aspect, a method for enabling purchase of an item is provided. The method is performed in a communication terminal.

The content of at least one communication session in which a user takes part is analysed. At least one part of at least one user profile is created based on said analysis. The user profile(s) is divided in more than one category. The created part(s) of the user profile(s) are conveyed to a purchase unit over a communication network, to be applied for matching the user with at least one provided item. Finally, the communication terminal receives a message from the purchase unit, the message including at least one purchase offer regarding item(s) matching the user profile.

According to yet another aspect, a communication terminal for providing purchase offers to a user regarding items offered by an item provider is provided. The communication terminal comprises an input unit adapted to record at least one communication session in which the user takes part. The communication terminal comprises also a profile processor adapted to analyse the content of the communication session(s), and further adapted to create at least one part of at least one user profile based on the analysis. A communication unit is comprised and is adapted to convey the part(s) of the user profile(s), and receive at least one message from the purchase unit including at least one purchase offer regarding at least one matching item. A presentation unit is further comprised and is adapted to present the at least one received message to the user.

The above method and arrangement may be used to provide a user with personalised purchase offers based on current characteristics of the user. The user may receive fewer non-interesting purchase offers, and the item providers may offer their items to more relevant purchasers.

### BRIEF DESCRIPTION OF THE DRAWINGS

The present invention will now be described in more detail by means of exemplary embodiments and with reference to the accompanying drawings, in which:

FIG. 1 is a basic overview illustrating a scenario where a network operator matches offered items with a user profile, in accordance with one embodiment

FIG. 2 is a flow chart illustrating a procedure for enabling purchase of an item, in accordance with another embodiment.

FIG. 3 is a block diagram illustrating a purchase unit, in accordance with another embodiment.

FIG. 4 is a flow chart illustrating steps of a procedure for enabling purchase of an item, in accordance with another embodiment.

FIG. 5 is a flow chart illustrating steps of a procedure for enabling purchase of an item, in accordance with another embodiment.

FIG. 6 is a block diagram illustrating a communication terminal, in accordance with another embodiment.

### DETAILED DESCRIPTION

Briefly described, a solution is provided where an item provider can send more personalised purchase offers to a user. Communication sessions in which a user takes part may be analysed to create user profiles based on the user's preferences. A purchase unit associated to a communication network, analyses one or more communication sessions in which a user takes part over the communication network and creates one or more user profiles regarding the user's preferences based on the analysis. The profile may include a plurality of categories regarding the user. An item provider sends one or more purchase offers regarding one or more offered items to the purchase unit, which matches offered items with user profiles, and conveys messages including purchasing offer(s) regarding matching items to the user.

By dividing the user profiles in a plurality of categories, the purchase unit is enabled to match the offered item(s) with more than one category, which may result in more personalised purchasing offers to be delivered to the users.

Additionally, it is also possible to provide the messages including the purchasing offer(s) with a verification code. This may enable the purchase unit to prepare feedback regarding the purchasing offers. The verification code may further enable the item provider to verify the purchase offer with the purchase unit, e.g. to find if the purchase offer is authentic and have not already been used. It is also possible to include the geolocation of the user or the session time when the communication session takes place. Including the session time and/or geolocation of a user in the user profiles, may enable the purchase unit to send a specific purchasing offer even more personalised.

The term “user profile” is used throughout this description to define a set of categories regarding a user. Each category may include at least one keyword or reference. For instance, such categories may be: preferences, needs, actions, interests, work place, home, income, emotional feeling, geolocation, session time, etc. Typically, the user profile(s) is stored in a memory at the purchasing offer controller in a suitable format, e.g. XML (eXtended Markup Language). The user profiles may be of different kinds. For instance, a short-time profile may contain information of a users intentions/plans and geolocation, when a long-time profile may contain information regarding further characteristics of the user, e.g. social life, interests, work place, etc. Examples of user profiles will be shown in some of the embodiments, described below.

In this description, the “content” of a communication session defines as well what is expressed in spoken words by a person, what is expressed by the characteristics of the person's voice, as well as a text-string written by a person. Typically, characteristics of a person's voice may give information regarding the emotional feelings, social belonging, and age of the person. Furthermore, the type of environment where the person is present may be found by analysing the communication session.

“Session time” is a term defining any of the time moment a communication session starts, or the time interval the communication session takes place, e.g. “Jan. 3, 2009”, or “8:45-13:30”.

With “geolocation” means where the user is present. It may be the cellID in which the user's communication terminal is present, but it may also be a GPS-position (Global Positioning System) which may be retrieved from any suitable network node of the communication network. Furthermore, by obtaining GPS-coordinates, the daily life route of the user may be determined, and the user may be offered items by his/her daily route, which is realised by the person skilled in the art.

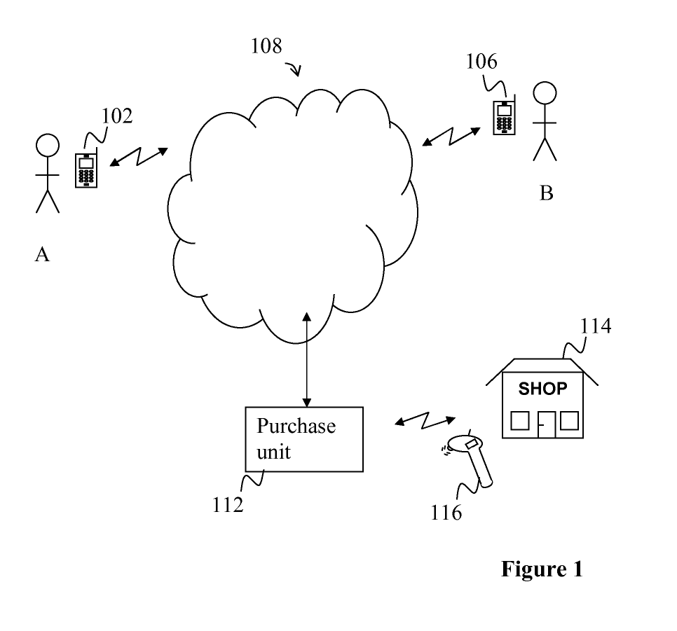

FIG. 1 illustrates a basic scenario where a user A communicates with another user B in a communication session over a communication network 108, and an item provider 114 provides purchase offers to the user A. The user A uses a first communication terminal 102 to communicate with the user B using a second communication terminal 106 in a communication session over the communication network 108. The communication session between the users A and B, is further forwarded to, and analysed by, a purchase unit 112, associated physically and/or logically to the communication network 108. However, alternatively, the purchase unit 112 may be associated to any suitable communication network node. The purchase unit 112 creates (or updates) one or more user profiles based on user A's preferences, detected during the analysis. Moreover, the item provider 114, sends at least one purchase offers to the purchase unit 112 regarding items to be provided to matching user(s). The purchase unit 112 matches items with the user's profile(s) to determine which user(s) who shall receive the purchase offer(s), composes at least one message including the purchase offer(s), and conveys the composed message(s) to matching user(s). Finally, the user A who receives the purchase offer(s) and makes use of it at the item provider 114, may show the message to the item provider 114, e.g. to get a discount.

Additionally, such an offering message may include a verification code, to be captured by the item provider when a user makes use of such a purchasing offer. The capturing of the verification code may be performed by a verification terminal 116 used by the item provider 114, and the capturing terminal 116 may send the verification code to the purchase unit 112. Thereby, the purchase unit 112 may evaluate the use of specific purchase offer(s) and give feedback to the item provider, as well as to the network operator. The item provider 114 may further get the purchase offer(s) verified with the purchase unit 112, e.g. by obtaining the captured verification code to the purchase unit 112.

Furthermore, the purchase unit 112 may also obtain information about the geolocation of the user A, e.g. in which cellID the user A is present, or at which session time the communication session takes place. Such information may be obtained from the communication network 108 and supplemented to the user profile(s), thereby further improving the personalization of purchasing offers to the user A.

Using a purchase unit for conveying purchase offers, enables a user to receive purchasing offers from item providers without having to give his/her identity to the item provider, e.g. phone number, which otherwise may be perceived as unsecure.

Typically, a network operator is being responsible for the service of providing purchasing offers by a purchasing unit. Such an operator may also exclude specific users, groups of users or item providers from using the service. For instance, a user or item provider who have misbehaved or a group of users being too young for a specific item may be excluded. Moreover, specific types of items may also be possible to exclude from being provided at all, e.g. items being unsuitable to provide. Furthermore, a specific user may also be able to select if he/she wants to use the service of receiving personalised purchasing offers. In the figure, the communication terminals are illustrated as mobile phones. However, a skilled person realises that also other communication terminals may be used in the manner described, e.g. handheld computers, laptop computers, etc.

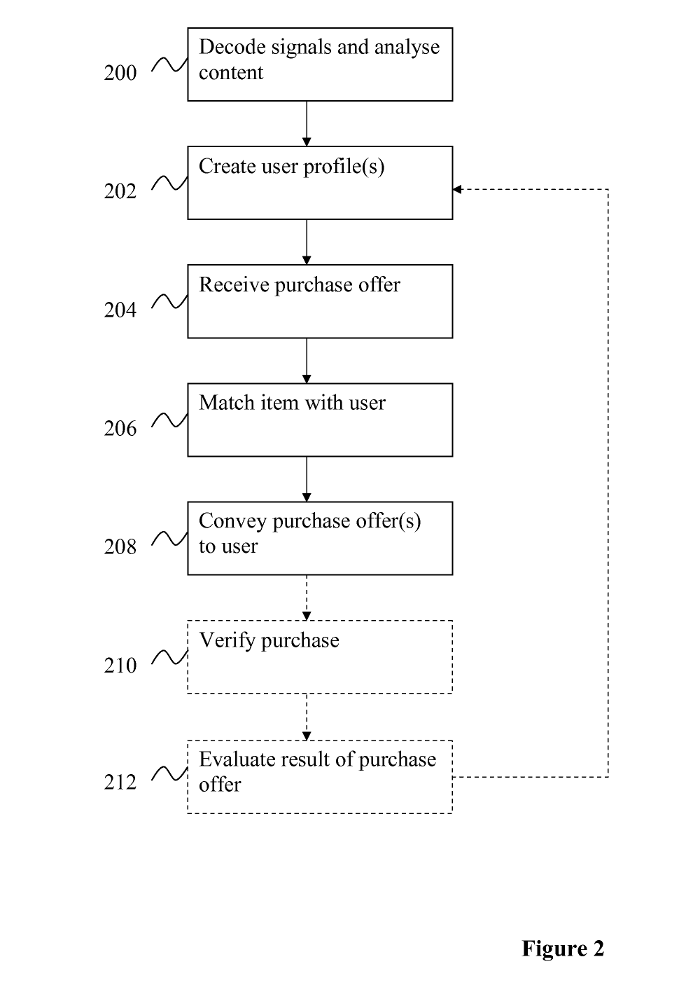

With reference to FIG. 2, an embodiment where a purchase unit controls provisioning of purchase offers from an item provider to a user A, will now be described. The user A according to this embodiment takes part in a communication session with another communication part B over a communication network. According to this embodiment, the following steps are performed in a purchase unit.

In a first step 200, the purchase unit, associated to the communication network, analyses the content of a communication session between the users A and B. Typically, the purchasing unit decodes signals representing the communication session, e.g. conveyed packet-distributed, into an audio signal or a text string. The decoding of signals may be performed by applying known methods for decoding and will therefore not be further described in this description. In the case where the result of the analysis is an audio signal, the analysis may further comprise a speech-to-text conversion process, resulting in a text-string. Additionally, also parameters characterising the person's voice and/or the emotional status, or the environment where the person is present may be analysed.

In a following step 202, the purchase unit creates at least one user profile based on the analysis performed in step 202. The creation of the user profile(s) is performed by categorising the content of the analysed communication session and sorting it into at least two categories. Such categories regarding users may be their: preferences, needs, actions, interests, type of housing, profession, emotional feelings, age group, etc. Additionally, also categories regarding a user, which may be determined by the communications network, may be used to create the profile(s). Such categories regarding a user may be: the geolocation of the user, the session time when a communication session takes place, etc. For determining the geolocation of the user, the cell ID (Identity) for the cell in which the user is present may be used. However, the invention is not limited to determine in which cell the user is present, any other suitable method may be used, e.g. obtaining the GPS coordinate from a user terminal having a GPS-receiver.

Furthermore, the purchase unit may already contain user profile(s) regarding a specific user. However, the method is not limited to creation of new profile(s), updating existing profile(s) will also be covered by the term “creating”, in the manner described.

The steps 200 and 202 will be further exemplified in another embodiment below.

In another step 204, the purchase unit receives at least one purchase offer from the item provider. Additionally, the item provider may optionally categorise the item provided, in order to offer the items to specific groups of users, thereby achieving further more personalised purchase offers. Moreover, the process is not limited to reception of the offers subsequent to the creation of the user profile(s), a skilled person realises that the reception of purchase offers from the item provider may be performed at any moment before the next step 206.

In the subsequent step 206, the offered items are matched with user(s) based on the user's profile(s) by the purchase unit. Typically, reception of a purchase offer from the item provider initiates the matching of the item with created/updated profile(s). However, a skilled person realises easy how to modify the process and match created/updated profiles with stored purchase offers, or to initiate the matching process at specific time intervals. Typically, the matching process will be performed by searching in the categories of the user's profile(s) for specific keywords or references present in the purchasing offer and determine the best matching users. Alternatively, the matching process may instead be performed by searching in the purchase offers for specific keywords or references present in at least one category and determine the best matching purchase offer.

Furthermore, a skilled person realises easy how to select a suitable method for determine the matches. Therefore, the selection of matching methods will not be further discussed in this description.

In another step 208, the matching purchase offer(s) are conveyed to the user. Typically, the conveyance can be implemented by sending a message, such as an SMS (Short Message Service), an MMS (Multimedia Messaging Service), or an URL (Uniform Resource Locator) to an HTML file (HyperText Markup Language) including the purchase offer(s). However, also other messages could be used for the conveyance, e.g. the purchase offer(s) may be viewed on a computer screen, which is easily realised by a skilled person.

Additionally, the message including the purchase offer(s) may include a verification code, e.g. a PIN-code, a bar-code, a two-dimensional bar-code, etc. Such a verification code may be shown to the item provider by the user when making use of the purchase offer(s).

The item provider may capture the verification code, e.g. in order to verify the purchase offer in an additional step 210. The item provider may then send the captured verification code to the purchase unit, which may check that the purchase offer is valid and/or authentic.

In a following optional step 212, the purchase unit may analyse the result of a specific purchase offer, e.g. in order to provide feedback. The analysis may be performed by analysing, e.g. how many verification codes being received, how many of these being valid and/or authentic, etc. The feedback may be forwarded to the item provider, which may use the feedback to evaluate a specific purchase offer. Optionally, the feedback may further be used by the purchase unit to update the user's profile(s), e.g. a category representing the how easily influenced the user is regarding purchase offered.

According to an additional embodiment, based on the embodiment above, a plurality of item providers may take part in a bidding process, organised by the purchase unit, for a specific profile. According to this embodiment, the item provider offering the best purchase offer will win the bidding and just his/her offer will be conveyed to the user(s).

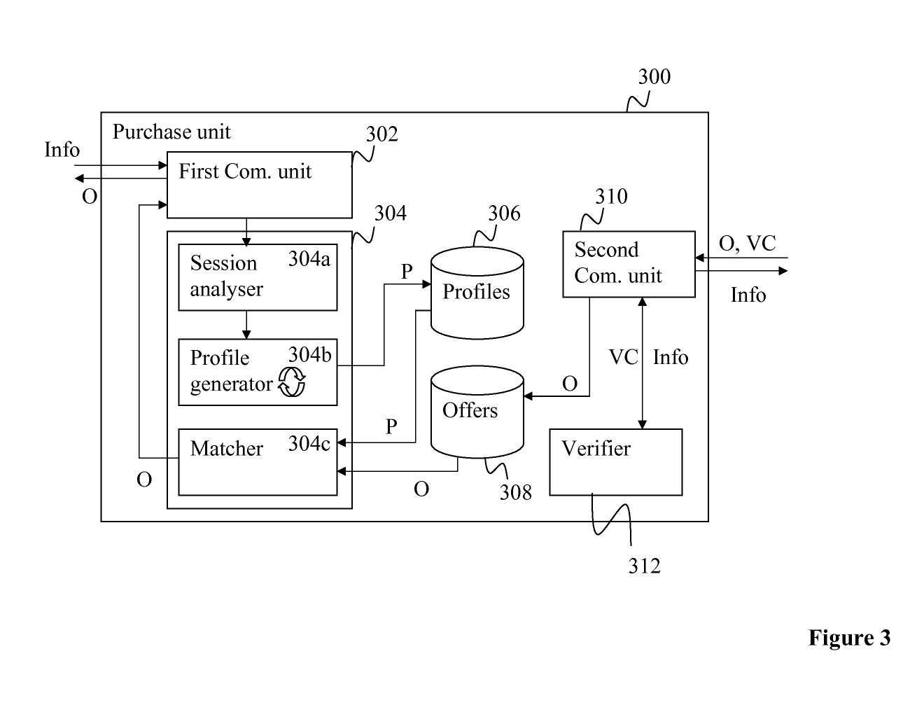

With reference to FIG. 3, an embodiment of a purchase unit 300 adapted to enable controlling of purchase offers from an item provider to a user A taking part in a communication session. The purchase unit 300 is adapted to be associated to a communication network, in which the user A takes part. The purchase unit 300 comprises a first communication unit 302, a profile processor 304, and a second communication unit 310. Furthermore, the purchase unit 300 may comprise a profile memory 306, a purchase memory 308, and a verifying unit 312. The first communication unit 302 is adapted to monitor the communication sessions proceeding in the communication network and retrieve the information in the communication sessions in which the user A takes part. The retrieval will be performed by copying the parts of the communication sessions in which the user A takes part and provide these parts to the purchase processor 304.

The purchase processor 304 is adapted to analyse the communication sessions in which the user A takes part. For performing this analysis, the purchase processor 304 is adapted to decode the information of the communication session(s) and convert the information into one or more text-strings. The purchase processor 304 is further adapted to extract the content of the communication session(s). Typically, extraction will be performed by extracting keywords from the communication session(s) by text-mining, which will be described in another embodiment below. However, the purchase processor 304 may be further adapted to analyse the user's voice to detect his/her emotional feelings, age, dialect, sociolect, etc. The above described analysis may be performed in a session analyser 304a, which may be contained in the purchase processor 304.

The purchase processor 304 is further adapted to generate one or more user profiles regarding the user A, based on the content in the communication session(s) in which user A takes part. The creation of the user profiles is performed by creating records regarding a plan, an intention, an interest, etc., which will be described in an embodiment below. The purchase processor 304 may contain a profile generator 304b adapted to create and or/update the user profile(s).

Furthermore, the purchase processor 304 is adapted to match offered items with users, and may also include a verification code in the matching purchase offers. For performing the matching process, the purchase processor 304 may contain a matching unit 304c. The purchase processor 304 is further adapted to supply the purchase offers relating to the matching item(s) to the first communication unit 302 (indicated by O in the figure), which is adapted to convey a message including the received offer(s) to the user. Moreover, the purchase unit 304 may comprise a profile memory 306 and an offer memory 308, adapted to store user profiles, and purchase offers, respectively.

A second communication unit 310 is further included in the purchase unit 300, and is adapted to receive purchase offers from at least one item provider. The second communication unit 310 is further adapted to provide these purchase offers to the purchase processor 304. Alternatively, the purchase offers may be stored in the offer memory 308, before being provided to the profile processor. Moreover, the second communication unit 310 may be further adapted to receive verification codes (indicated by VC in the figure) from the item provider. The second communication unit 310 may be further provided to supply the received verification codes to the verifying unit 312, which may be adapted to verify them and convey information (indicated by Info in the figure) to the second communication unit 310 regarding the result of the verification. The second communication unit 310 may be further adapted to convey the result of the verification to the item provider.

Additionally, the purchase processor 304 may be adapted to obtain the geolocation where the user is present, and/or the session time regarding the communication session. This information may be obtained from the communication network and may further be applied when creating user profile(s). Typically, the geolocation is represented by the cell ID regarding the cell where the user is present. However, the geolocation may alternatively be represented by the GPS-coordinate of the user, etc.

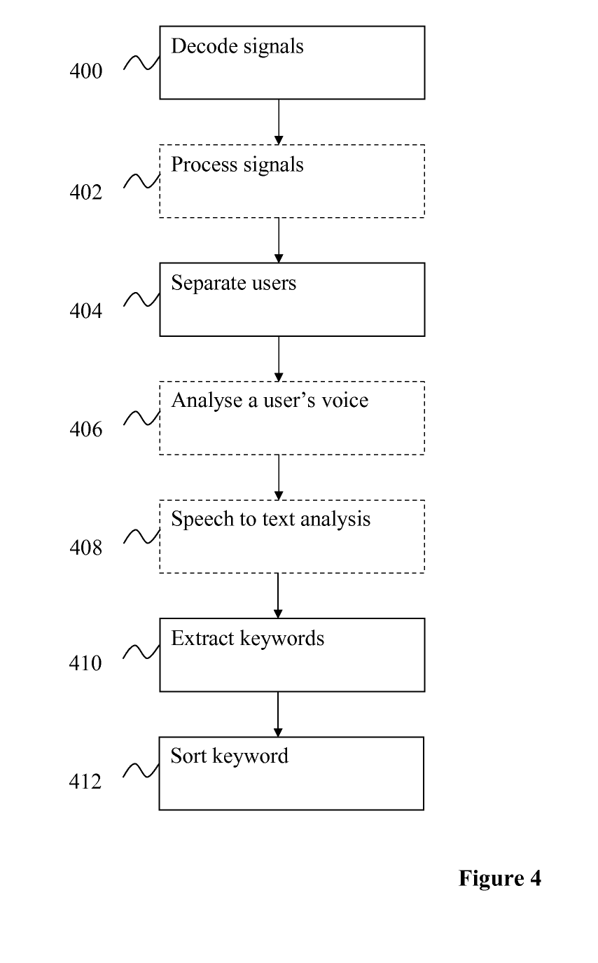

It should be noted that FIG. 3 merely illustrates various functional units in the purchase unit 300 in a logical sense, although the skilled person is free to implement these functions in practice using any suitable software and hardware means. Thus, the invention is generally not limited to the shown structure of the purchase unit 300, while its functional units may be configured to operate according to the methods and procedures described above for FIGS. 2 and 4, where appropriate.

Furthermore, it is to be understood that the purchase unit described above in this description also comprises additional conventional means providing functionality, such as e.g. various control units and memories, necessary for enabling common functions and features to operate properly. However, for simplicity reasons, any means or functionality which is not necessary for the understanding of the proposed enabling of the personalised purchase offering services has been omitted in the figures, and will not be discussed in any further detail in this description.

Additionally, according to another embodiment, a billing system may be associated to the purchase unit. Associating a billing system may enable a user to purchase an offered item at the item provider and being charged via the network operator.

With reference to FIG. 4, an embodiment where a purchase unit creates user profiles for a user taking part in a communication session will now be described. The user A according to this embodiment takes part in a communication session with another communication part B over a communication network. According to this embodiment, the following steps are performed in a purchase unit.

In a first step 400, the purchase unit, associated to the communication network, decodes the signals of the communication session in which the user A takes part. The result of the decoding is the communication session, e.g. a conversation between user A and at least one other communicating party, or a text string. Typically, the communication is packet distributed. As mentioned in above, the decoding may be made by known methods, and will therefore not be further described.

In another optional step 402, the decoded communication session may be processed, e.g. noise reduced, etc.

In a following step 404, the communication session is separated, in order to isolate the sequences regarding to user A. The separation process is typically performed by known methods and will therefore not be described in more detail.

In an optional step 406, which may be performed if the communication session is a speech signal, the characteristics of the voice of user A may be analysed. This analyse may be performed to detect additional information of the user A, which are not expressed by spoken words. Such information may be: the user's emotional feelings, the user's age, the user's sociolect, the user's dialect, the user's physical condition, etc. Furthermore, the type of environment where the person is present may be found by analysing the communication session. Moreover, the analysis according to this step will be performed by known methods and will therefore not be further discussed.

In another optional step 408, which also may be performed if the communication session is a speech signal, the speech signal will be converted into text. Speech-to-text modules are known and will therefore not be further described. The result of step 408 is a text-string.

In a subsequent step 410, keywords will be extracted from the text-string. The keyword analysis according to this embodiment will be performed by applying text mining. Typically, text mining will be performed by removing stopwords and stemmings of the words. For instance, a text-string may be processed as shown in the example below.

| | Result | Removed |
|---|---|---|
| Original | I will be working | |
| text | in the bank | |
| | tomorrow | |
| Removing | will be working | Articles, |
| stopwords | in bank tomorrow | determiners, |
| | | quantifiers, |
| | | conjunctions, |
| | | Particles etc. |
| Removing | will be work in | Suffixes (ing-format) |
| stems | bank tomorrow | Plurals, etc. |

According to this embodiment, stopwords and stems are removed by text mining. However, the invention is not limited to text mining, a skilled person realises how to apply other methods and implement these for keyword extraction, e.g. statistical language processing, natural language processing etc.

In a final step 412, the keywords are sorted into categories by the purchase unit. The categories may be pre-defined by any suitable part, e.g. the purchasing unit. An example of such categories is shown below.

| | Categories | Examples |
|---|---|---|
| A | Activities | shop, coffee, party, store, training . . . |
| B | Time frames | Now, minutes, hours, tomorrow . . . |
| C | Intentions | go to, work until, will be, meet at, |
| | | buy, come to, go shop . . . |
| D | Locations | town specific landmarks, locations, |
| | | stores, GPS-coordinates . . . |
| E | Named | persons, companies, organsiations, |
| | entities | authors, actors . . . |
| F | Events | calendar, events relating to sporting, |
| | | theatrical, movies . . . |
| G | Items | Bag, clock, trouser, financial service, |
| | | house cleaning . . . |

However, the list above is just an example of categories; a skilled person may easy modify the categories or supplement further categories to the list.

An embodiment where a user profile is created will now be described. The purchase unit extracts keywords regarding various characteristics from a communication session. The content of a communication session is sorted into at least one record. In this embodiment the records are formatted according to the XML-format. However, a skilled person may be able to select also other suitable formats.

A speech session “I will be working in the bank tomorrow”, will be stored as the following record:

<?xml version=″1.0″?>
<plan id=”1003”>
<activity></activity>
<time_frame>Mar. 21, 2009</time_frame>
<intention>will be</intention>
<intention>work in</intention>
<location>bank</location>
</plan>

From the session the purchase processor analysed that the user's intention/plan was to work and that the work should be performed at a bank tomorrow. From the communication network, the purchase unit obtained information of the time session and analysed that tomorrow was Mar. 21, 2009. Furthermore, the record got an identification number “1003”. One or more records define a user profile. When the purchase processor matches items with user profiles, a profile containing the record above might be matching purchasing offers regarding banks and Mar. 21, 2009.

The example above shows a short-time record. Typically, short-time records are defining the characteristic of the user's intentions. Long-time profiles, on the other hand, can be more detailed and define more characteristics of the user. For instance a user saying “I was training but my running shoes are getting old”, could be offered to purchase running shoes from a sports store near his/her home or work place. For that purpose, the purchase processor might have stored a set of records and identified the user's workplace and home by analysing geolocation data obtained associated to communication sessions on workdays and weekends, respectively. Furthermore, in addition, if the user's communication terminal comprises a GPS unit and his/her daily route is comprised in the user profile(s), purchase offers along the route might also be offered.

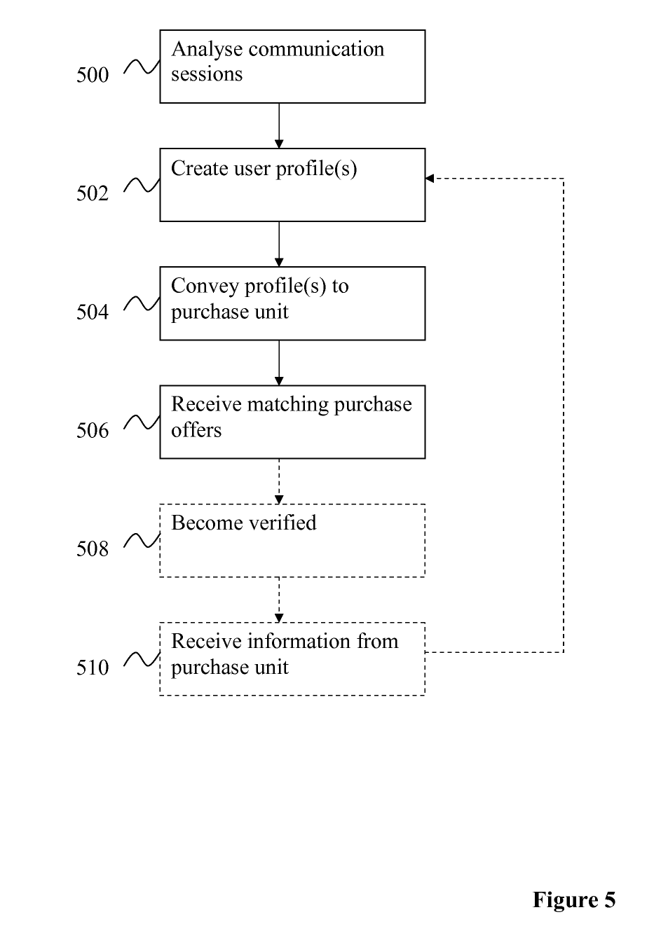

With reference to FIG. 5, an embodiment where a communication terminal analyses the content of a communication session and enables provisioning of purchase offers from an item provider, will now be described. The user A according to this embodiment takes part in the communication session with another communication part B over a communication network. According to this embodiment, the following steps are performed in the communication terminal.

In a first step 500, the communication terminal, operated by the user A, analyses the content of the communication session between the users A and B. Typically, the analysis results in a text-string representing the sequence(s) of the content regarding the user A. Correspondingly, as described in an embodiment above, in the case where the result of the analysis is an audio signal, the analysis may further comprise a speech-to-text conversion process, resulting in a text-string. Additionally, also parameters characterising the person's voice and/or the emotional status, or the environment where the person is present may be analysed.

In a following step 502, executed in association to the communication session, the communication terminal creates one or more parts of one or more user profiles based on the analysis performed in step 502. Furthermore, as described in an embodiment above, the process of creating part(s) of the user profile(s) may comprise obtaining of geolocation and/or session time, to be included in the user profile(s). The part(s) of the created user profile(s) are then conveyed to the purchase unit in another step 504, to be used for creating or updating user A's profile(s) stored in the purchase unit.

In a subsequent step 506, the communication terminal receives at least one purchasing offer regarding an item from the purchase unit, the purchase offer being the result of a matching process between offered item(s) by an item provider and at least one of the user profile(s) regarding the user A.

Additionally, the purchase offer(s) may include a verification code, which may be shown to the item provider in an additional following step 508 when purchasing the offered item. As described in an embodiment above, this verification code enables the item provider to verify the purchase offer, with the purchase unit.

Optionally, according to an alternative embodiment based on the embodiment above, the communication terminal may create complete user profile(s) in step 502, to be conveyed to the purchase unit in step 504. Furthermore, according to this alternative embodiment, in a following step 510, the communication terminal may receive feedback information from the purchase unit, to be used for updating the user profile(s) stored in the communication terminal. Such feedback information may indicate how easily influenced the user is, etc.

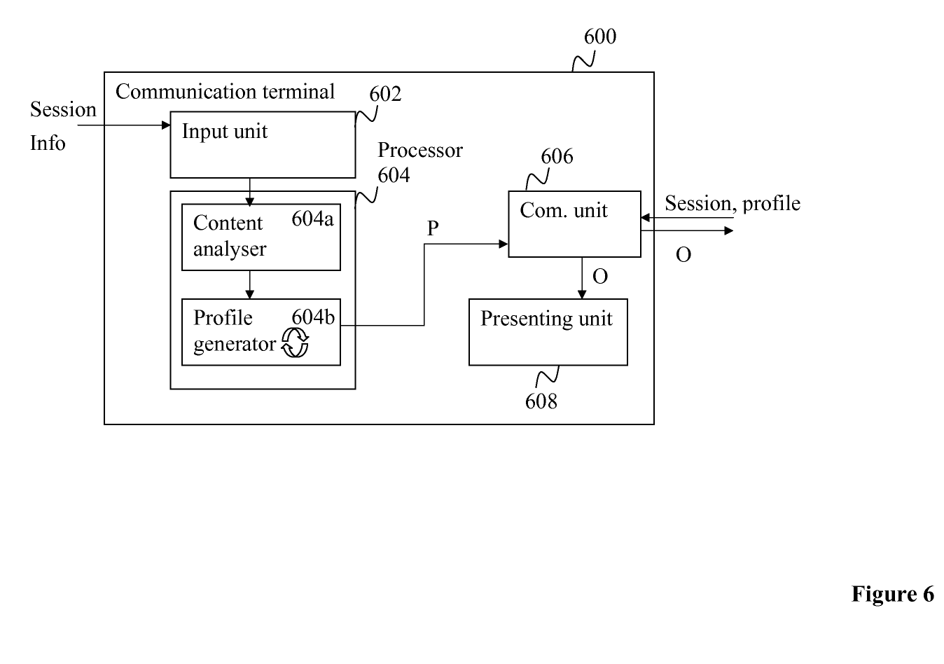

With reference to FIG. 6, an embodiment of a communication terminal 600 adapted to providing purchase offers to a user regarding items offered by an item provider will now be described. The communication terminal 600 comprises an input unit 602, a profile processor 604, a communication unit 606, and a presentation unit 608. Typically, the communication terminal may be implemented in a mobile phone, e.g. a user equipment. However, the embodiment is not limited thereto, any other suitable communication terminal may be used in the manner described, e.g. a handheld computer or laptop computer, etc.

The input unit 602 is adapted to record at least one communication session in which the user A takes part (indicated with Session), and support to a profile processor 604. Typically, the communication session will be a speech performed. However, the invention is not limited to speech, the communication session may alternatively be performed by text sequences, or a combination thereof, etc.

The profile processor 604 is adapted to analyse the content of the communication session(s), and extract keywords there from. Correspondingly to an embodiment above, the profile processor 604 may further comprise a speech-to-text converter, adapted to convert the communication session(s) into text. Furthermore, corresponding to the above described embodiment, the profile processor 604, may be further adapted to extract characteristics of the user's voice, the environment of the user, etc., as well as it may be further adapted to obtain geolocation and/or session time.

Moreover, the profile processor 604 is adapted to create at least one part of the user A's user profile(s). The creation of the part(s) of the user profile(s) corresponds to the creation performed in an embodiment above, and is therefore not further discussed. Correspondingly to an embodiment described above, the profile processor 604 may comprise a session analyser 604a, and a profile generator 604b, adapted to perform the corresponding processes. The profile processor 604 is further adapted to create and supply the created part(s) of the user profile(s) to the communication unit 606 (indicated by P).

The communication unit 606 is adapted to convey the created part(s) of the user profile(s) to the purchase unit. The communication unit 606 is further adapted to receive at least one purchase offer regarding a matching item from the purchase unit (indicated with O). The conveying of is typically performed by the communication unit used for communicating the communication session to the communication network. However, the invention is not limited thereto; the communication terminal 600 may alternatively be implemented to comprise a specific communication unit 606 adapted to convey the created part(s) of the user profile(s).

The presentation unit 608 is adapted to present purchase offer(s) received from the purchase unit via the communication unit 608 to the user. For instance, the presentation unit 608 may be implemented as a display.

The communication terminal 600 may further be adapted to store the user's profile(s) in a memory (not shown), and the profile processor 604 may further be adapted to update the stored user profile(s). Additionally, the communication unit 606 may be adapted to receive information from the purchase unit, intended to be used for updating user profile(s) stored in the communication terminal 600.

According to an alternative embodiment, based on the embodiment above, the input unit 602 may further be adapted to record information inputted by the user (indicated by Info). Such information may be that the user wants to start/stop the service of receiving personalised purchase offers, or that the user may influence his/her user profile(s), etc.

Furthermore, it is to be understood that the communication terminal also comprises additional conventional means providing functionality, such as e.g. output units, various control units and memories, necessary for enabling common functions and features to operate properly. However, for simplicity reasons, any means or functionality which is not necessary for the understanding of the proposed enabling of the terminating services has been omitted in the figure, and will not be discussed in any further detail in this description. It is also to be understood that the communication terminal comprises means for communicating the communication session with another part B, using another suitable communication terminal.

By means of the present invention, a method for providing a user with personalised purchase offers based on current characteristics of the user is achieved. A purchase unit provides personalised purchase offers to a user from an item provider, matching the user's profile, instead of providing an amount of generic purchase offers. The user may receive fewer non-interesting purchase offers, and the item providers may offer their items to more relevant purchasers.

Furthermore, by providing the purchase offers by a purchase unit, the user does not have to give any personal information to the item providers, e.g. phone number. Moreover, by providing the purchase offers with a verification code, the item provider can verify the purchase offers being made use of. The item provider may also get feedback on a specific purchase offer.

The invention is generally defined by the following independent claims.

### ABBREVIATION LIST

GPS Global Positioning System
HTML HyperText Markup Language
MMS Multimedia Messaging Service
PIN Personal Identification Number
SMS Short Message Service
XML eXtended Markup Language

1. A method for enabling purchase of an item, comprising the following steps executed in a communication network node:
analysing (200) the content of at least one communication session in which a user takes part,
creating (202) at least one user profile based on said analysis, the user profile being divided in more than one category,
receiving (204) at least one purchase offer regarding at least one item from an item provider,
matching (206) the item with the user based on the created user profile, and
conveying (208) a message to the user including at least one purchase offer regarding the at least one matching item.

2. The method according to claim 1, wherein the categories of the profile(s) comprises at least one of: the user's preferences, the user's needs, the user's actions, the user's interests, the user's work profession, the user's type of home, the user's emotional feelings, the user's age, the user's physical condition, and the user's income.

3. The method according to claim 1 or 2, wherein the communication sessions comprises speech and/or text and the analysis is performed by extracting keywords from the speech and/or text.

4. The method according to claim 3, wherein, if the communication session comprises speech, the speech is converted into text and the keyword extraction is based on said text.

5. The method according to any of claims 1 to 4, wherein the creating of the user profiles is further based on at least one reference of: the user's geolocation and the session time when the session takes place, and the matching is further based on matching at least one reference.

6. The method according to any of claims 1 to 5, wherein creating of the user profile(s) includes updating of existing user profiles.

7. The method according to any of claims 1 to 6, wherein the sent message includes a verification code, and the method further comprises reception of the verification code from the item provider in association to a purchase, the verification code being captured by the provider.

8. A purchase unit (300) for providing purchase offers to a user regarding items offered by an item provider comprising:
a first communication unit (302) adapted to receive information on at least one communication session in which a user takes part,
a profile processor (304) adapted to analyse the content of the communication session, and further adapted to create at least one user profile based on the analysis,
a second communication unit (306) adapted to receive the purchase offers from the item provider,
the profile processor (304) being further adapted to match at least one offered item with the user based on at least one user profile, and the first communication unit (302) is further adapted to convey to the user at least one message including the at least one purchase offer regarding the at least one matching item.

9. The purchase unit according to claim 8 further comprising:
a profile storage unit (306) adapted to store at least one user profile, and
an offer storage unit (308) adapted to store at least one purchase offer.

10. A method for enabling purchase of an item, comprising the following steps executed in a communication terminal:
analysing (500) the content of at least one communication session in which a user takes part,
creating (502) at least one part of at least one user profile based on said analysis, the user profile being divided in more than one category,
conveying (504) the at least one created part of the user profile to a purchase unit over a communication network, the at least one user profile to be applied for matching the user with at least one provided item, and
receiving (506) a message from the purchase unit, the message including at least one purchase offer regarding the item matching the user profile.

11. A communication terminal (600) for providing purchase offers to a user regarding items offered by an item provider comprising:
an input unit (602) adapted to record at least one communication session in which the user takes part,
a profile processor (604) adapted to analyse the content of the communication session, and further adapted to create at least one part of at least one user profile based on the analysis,
a communication unit (606) adapted to convey the part of the user profile, and receive at least one message from the purchase unit including at least one purchase offer regarding at least one matching item,
a presentation unit (608) adapted to present the at least one received message to the user.

12. The communication terminal according to claim 11, wherein the input unit (602) is further adapted to record at least one setting inputted by the user, and the profile processor (604) is further adapted to include at least one inputted setting in the at least one part of the at least one user profile.

13. The communication terminal according to claim 11, wherein the input unit (602) is further adapted to record at least one setting inputted by the user, and the communication unit (606) is further adapted to convey the at least one inputted setting to the purchase unit, to be used for creating the at least one user profile.
